(19) United States
(12) Patent Application Publication
(10) Pub. No.: US 2019/0257127 A1
(43) Pub. Date: Aug. 22, 2019

(54) DOOR CLOSER WITH A DOORJAMB MOUNTING PLATE

(71) Applicant: Gerald Michael Hogan, New Waterford (CA)

(72) Inventor: Gerald Michael Hogan, New Waterford (CA)

(21) Appl. No.: 16/278,134

(22) Filed: Feb. 17, 2019

Related U.S. Application Data
(60) Provisional application No. 62/631,711, filed on Feb. 17, 2018.

(51) Int. Cl. E05F 1/10

(52) U.S. Cl. CPC E05F 1/105; E05Y 2900/602; E05Y 2900/132

(57) ABSTRACT

A door closer with a doorjamb mounting plate is a screen door closer or a closer for a similar purposes that has an enlarged door jamb bracket that is attached with at least eight fasteners and has an integrally attached extension that allows for pivotally connecting the extendable arm of a spring loaded or gas tube closer. The closer attaches to the door or the lid and the extension on the enlarged door jamb bracket is optimally designed and angled to reduce stress on the door jamb.

### CROSS-REFERENCE TO RELATED APPLICATION

The present application is related to and claims priority from prior provisional application Ser. No. 62/631,711, filed Feb. 17, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of door closing hardware and more specifically relates to a door closer with a doorjamb mounting plate.

### 2. Description of the Related Art

A screen door can refer to a hinged, glassed in door, or a storm door as it is called in extreme climates, or a hinged, screened door generally used in milder climates that are attached to a doorway covering an exterior door. A screen door is also a screened sliding door used with sliding glass doors. In any case, the screen door usually incorporates screen mesh to block flying insects or airborne debris such as seeds or leaves from entering, they allow ambient air and light to pass through, and they prevent pets and small children from exiting the interior spaces.

Most screen doors are lightweight and hinged on one side, and generally not intended for security purposes. Most screen doors sold on the market today also include an automatic screen door closer. The automatic closer is generally cylindrical and has a rod that extends from the center of the cylinder and has a mount bracket on one end of the closer and a mount bracket on the outer end of the rod. The design provides the characteristic of pulling the rod into the cylinder. When the closer is mounted to a screen door, the bracket end of the cylinder is mounted to the door jamb. When the door is opened the rod, against spring and or gas pressure, extends from the cylinder and when the door is released by the person that opened it, the rod withdraws automatically back into the cylinder. The cylinder must have more than enough force to close the door again so that it will work even in unfavorable conditions. Herein lies the problem though; the extra retraction force of the cylinder eventually over time rips the bracket from the door jamb leaving stripped out holes that necessitate having to remount the bracket in a new location or it necessitates the replacement of the facing around the door. Out of the first five repairs that are done on or in connection with the screen door, three of these repairs will most likely be the repair mentioned above. This is an annoying problem that very much needs a solution to prevent such time consuming and bothersome repairs.

Various attempts have been made to solve the above-mentioned problems such as those found in U.S. Pat. No. 3,838,539 to Gronowicz W; U.S. Pat. No. 5,379,821 to Pergolizzi et al.; U.S. Pat. No. 2,489,072 to Ausubel Henry; U.S. Pat. No. 4,130,311 to Frank M. Sushan; and U.S. Pat. No. 9,127,505 to Olberding et al. This art is representative of door closing hardware. None of the above inventions and patents, taken either singly or in combination, is seen to describe the invention as claimed.

Ideally, door closing hardware should provide positive door closing with door jamb reinforcing, and yet, would operate reliably and be manufactured at a modest expense. Thus, a need exists for a reliable door closer with a doorjamb mounting plate to avoid the above-mentioned problems.

### BRIEF SUMMARY OF THE INVENTION

In view of the foregoing disadvantages inherent in the known door closing hardware art, the present invention provides a novel door closer with a doorjamb mounting plate. The general purpose of the present invention, which will be described subsequently in greater detail, is to provide a positive door closing with door jamb reinforcing.

The door closer with a doorjamb mounting plate protecting the part of the doorjamb to which the doorjamb mounting plate is attached may comprise a jamb bracket including a doorjamb mounting plate and a bracket extension with the doorjamb mounting plate being sized horizontally to cover the horizontal part of the doorjamb to which the doorjamb mounting plate is attached. The doorjamb mounting plate is substantially flat and square and is attached by at least six fasteners to the doorjamb. The bracket extension of the jamb bracket is connected substantially perpendicular to one face of the doorjamb mounting plate and the bracket extension is connected approximately on the center left side of the doorjamb mounting plate with the bracket extension having a pin at its distal end from the doorjamb mounting plate. A closer having a spring element with an extendible arm is connected in a generally horizontally rotatable manner to the pin of the bracket extension and the closer includes an end element attached at the end of the closer opposite to the pin. The end element attached in a limited horizontally slidable fashion to a door mounting plate. The doorjamb mounting plate is attached by at least seven fasteners to the doorjamb but may be attached by at least eight fasteners to the doorjamb. In some embodiments, the doorjamb mounting plate may be attached by at least nine fasteners to the doorjamb. The fasteners are preferably screws.

A door closer that protects the part of the door jamb to which the door closer is attached comprises a mounting plate for attaching the door closer to a part of the door jamb with the mounting plate being substantially flat and being sized horizontally to cover the horizontal part of the doorjamb to which the mounting plate is attached. The mounting plate is attached by at least six fasteners to the doorjamb. An extension is connected substantially perpendicular to one face of the mounting plate and approximately on the center left side of the mounting plate. The extension has a pin at its distal end from the mounting plate and the closer has a spring element with an extendible arm connected in a generally horizontally and rotatable manner to the pin of the extension. The closer includes an end element attached at the end of the closer opposite to the pin and the end element attaches to a door mounting plate. The end element is attached in a limited horizontally and slidable fashion to the door mounting plate and the extension is substantially triangular shaped with the pin at the apex of the extension. The mounting plate is attached by at least seven fasteners to the doorjamb but preferably is attached by eight or nine fasteners. The fasteners are preferably screws and the mounting plate is substantially square but may be rectangular in shape.

A closer for closing an element over a jamb lined opening may comprise a jamb bracket including a mounting plate and a bracket extension with the mounting plate being sized horizontally to cover at least the horizontal part of the jamb to which the mounting plate is attached and with the mounting plate being substantially flat and attached by at least six fasteners to the jamb. The bracket extension of the jamb bracket is connected substantially perpendicular to one face of the mounting plate and on approximately the center left side of the mounting plate. The bracket extension preferably has a pin at its distal end from the mounting plate for pivotal attachment to an extendible arm of a closer. The closer has an interior spring element with an extendible arm connected in a generally horizontally rotatable manner to the pin of the bracket extension and the closer includes an end element attached at the end of the closer opposite to the pin. The end element is attached to the element, which is a door. The element may comprise a lid or other pivotal planar object if used for other purposes than for a door closure. The jamb lined opening may comprise an open topped container or other similar structure. The element may comprise a cover and the jamb lined opening may comprise an open topped box. The mounting bracket may be substantially square or rectangular. The mounting plate may be attached by at least nine fasteners to the element and the fasteners may be bolts or other similarly threaded devices.

The present invention holds significant improvements and serves as a door closer with a doorjamb mounting plate. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, door closer, constructed and operative according to the teachings of the present invention.

FIG. 1 shows a perspective view illustrating a door closer with a doorjamb mounting plate according to an embodiment of the present invention.

FIG. 2 is a perspective view illustrating a door closer that protects the part of the door jamb according to an embodiment of the present invention.

FIG. 3 is a perspective view illustrating a closer for closing an element over a jamb lined opening according to an embodiment of the present invention of.

FIG. 4 is a perspective view illustrating a closer for closing an element over a jamb lined opening according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to door closing hardware and more particularly to a door closer with a doorjamb mounting plate as used to improve the door jamb reinforcing of a door closer.

Generally speaking, door closer with a doorjamb mounting plate is a screen door closer or a closer for a similar purposes that has an enlarged door jamb bracket that is attached with at least eight fasteners and has an integrally attached extension that allows for pivotally connecting the extendable arm of a spring loaded or gas tube closer. The closer attaches to the door or the lid and the extension on the enlarged door jamb bracket is optimally designed and angled to reduce stress on the door jamb.

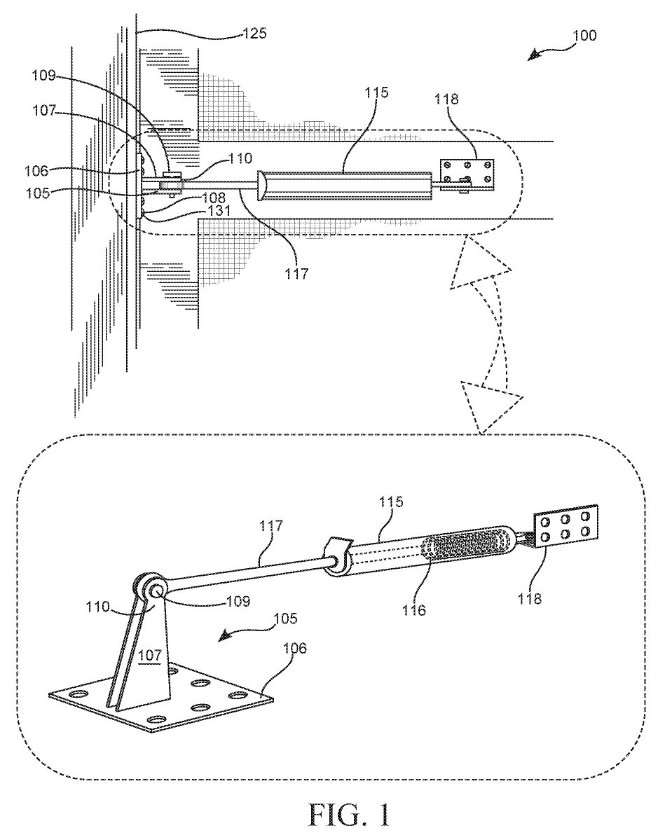

Referring to the drawings by numerals of reference there is shown in FIG. 1, a perspective view illustrating door closer with a doorjamb mounting plate 100 according to an embodiment of the present invention.

Door closer with a doorjamb mounting plate 100 protecting the part of doorjamb 125 to which doorjamb mounting plate 106 is attached may comprise jamb bracket 105 including doorjamb mounting plate 106 and bracket extension 107 with doorjamb mounting plate 106 being sized horizontally to cover the horizontal part of doorjamb 125 to which doorjamb mounting plate 106 is attached. Doorjamb mounting plate 106 is substantially flat and square and is attached by at least six fasteners to doorjamb 125. Bracket extension 107 of jamb bracket 105 is connected substantially perpendicular to one face of doorjamb mounting plate 106 and bracket extension 107 is connected approximately on the center left side of doorjamb mounting plate 106 with bracket extension 107 having pin 109 at its distal end 110 from doorjamb mounting plate 106. Closer 115 having spring element 116 with extendible arm 117 is connected in a generally horizontally rotatable manner to pin 109 of bracket extension 107 and closer 115 includes end element 118 attached at the end of closer 115 opposite to pin 109. End element 118 attached in a limited horizontally slidable fashion to doorjamb mounting plate 106. Doorjamb mounting plate 106 is attached by at least seven fasteners 108 to doorjamb 125 but may be attached by at least eight fasteners 108 to doorjamb 125. In some embodiments, doorjamb mounting plate 106 may be attached by at least nine fasteners 108 to doorjamb 125. Fasteners 130 are preferably screws 131.

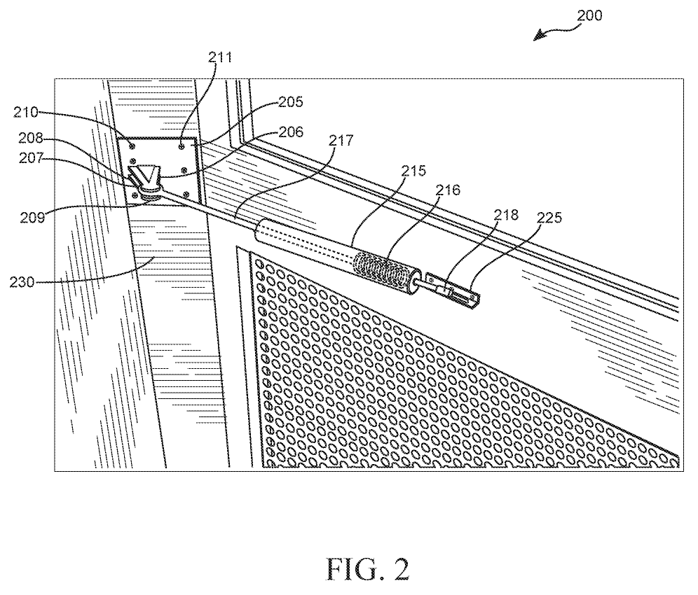

Referring now to FIG. 2, is a perspective view illustrating door closer that protects the part of the door jamb 200 according to an embodiment of the present invention of FIG. 1.

Door closer that protects the part of the door jamb 200 to which door closer 215 is attached comprises mounting plate 205 for attaching door closer 215 to a part of doorjamb 230 with mounting plate 205 being substantially flat and being sized horizontally to cover the horizontal part of doorjamb 230 to which mounting plate 205 is attached. Mounting plate 205 is attached by at least six fasteners 210 to doorjamb 230. Extension 206 is connected substantially perpendicular to one face of mounting plate 205 and approximately on the center left side of mounting plate 205. Extension 206 has pin 208 at its distal end 207 from mounting plate 205 and door closer 215 has spring element 216 with an extendible arm 217 connected in a generally horizontally and rotatable manner to pin 208 of extension 206. Door closer 215 includes end element 218 attached at the end of door closer 215 opposite to pin 208 and end element 218 attaches to door mounting plate 225. End element 218 is attached in a limited horizontally and slidable fashion to door mounting plate 225 and extension 206 is substantially triangular shaped with pin 208 at apex 209 of extension 206. Mounting plate 205 is attached by at least seven fasteners 210 to doorjamb 230 but preferably is attached by eight or nine fasteners 210. Fasteners 210 are preferably screws 211 and mounting plate 205 is substantially square but may be rectangular in shape.

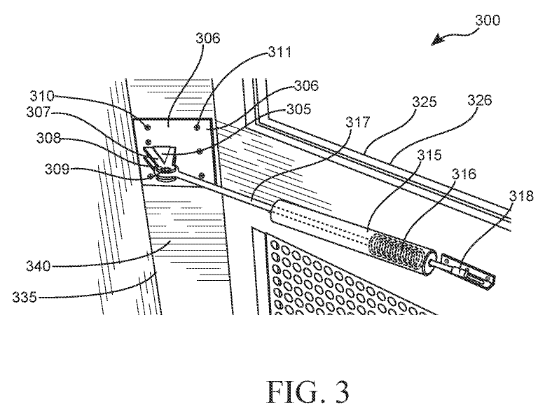

Referring now to FIG. 3, is a perspective view illustrating closer for closing an element over a jamb lined opening 300 according to an embodiment of the present invention of FIG. 1.

Closer for closing an element over a jamb lined opening 300 may comprise jamb bracket 305 including mounting plate 306 and bracket extension 307 with mounting plate 306 being sized horizontally to cover at least the horizontal part of jamb 340 to which mounting plate 306 is attached and with mounting plate 306 being substantially flat and attached by at least six fasteners 310 to jamb 340. Bracket extension 307 of jamb bracket 305 is connected substantially perpendicular to one face of mounting plate 306 and on approximately the center left side of mounting plate 306. Bracket extension 307 preferably has pin 309 at distal end 308 from mounting plate 306 for pivotal attachment to extendible arm 317 of closer 315. Closer 315 has an interior spring element 316 with extendible arm 317 connected in a generally horizontally rotatable manner to pin 309 of bracket extension 307 and the closer includes end element 318 attached at the end of closer 315 opposite to pin 309. End element 318 is attached to element 325, which is door 326. Element 325 may comprise a lid or other pivotal planar object if used for other purposes than for door 326 closure. Jamb lined opening 335 may comprise an open topped container or other similar structure. Element 325 may be a cover and jamb lined opening 335 may comprise an open topped or open sided box. Mounting plate 306 may be substantially square or rectangular and may be attached by at least nine fasteners 310 to jamb 340 and fasteners 310 may be bolts 311 or other similarly threaded devices.

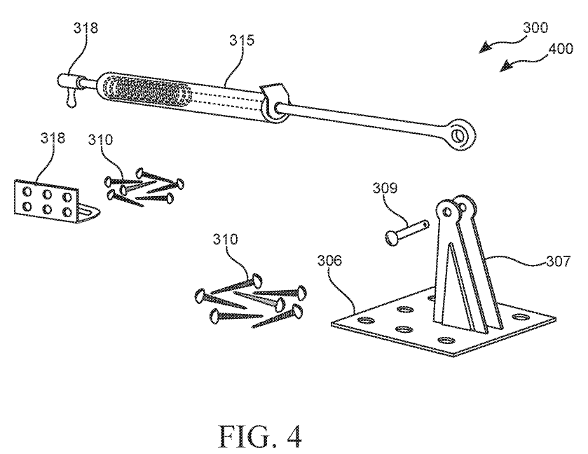

Referring now to FIG. 4, showing is a perspective view illustrating closer for closing an element over a jamb lined opening 300 according to an embodiment of the present invention of FIGS. 1-3. closer for closing an element over a jamb lined opening 300 may be sold as kit 400 comprising the following parts: at least one doorjamb mounting plate 306 with attached bracket extension 307; at least one fastener 310; at least one pin 309; at least one closer 315 having end element 318; and at least one set of user instructions. The kit has instructions such that functional relationships are detailed in relation to the structure of the invention (such that the invention can be used, maintained, or the like in a preferred manner). Door closer with a doorjamb mounting plate 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A door closer with a doorjamb mounting plate protecting the part of the doorjamb to which the doorjamb mounting plate is attached, comprising:
a jamb bracket including a doorjamb mounting plate and a bracket extension;
the doorjamb mounting plate being sized horizontally to cover the horizontal part of the doorjamb to which the doorjamb mounting plate is attached,
the doorjamb mounting plate being substantially flat and square, and
the doorjamb mounting plate being attached by at least six fasteners to the doorjamb;
the bracket extension of the jamb bracket being connected substantially perpendicularly to one face of the doorjamb mounting plate,
the bracket extension being connected approximately on the center left side of the doorjamb mounting plate, and
the bracket extension having a pin at its distal end from the doorjamb mounting plate;
a closer having a spring element with an extendible arm connected in a generally horizontally rotatable manner to the pin of the bracket extension, and
the closer including an end element attached at the end of the closer opposite to the pin; and
the end element attached in a limited horizontally slidable fashion to a door mounting plate.

2. The door closer of claim 1, wherein the doorjamb mounting plate is attached by at least seven fasteners to the doorjamb.

3. The door closer of claim 1, wherein the doorjamb mounting plate is attached by at least eight fasteners to the doorjamb.

4. The door closer of claim 1, wherein the doorjamb mounting plate is attached by at least nine fasteners to the doorjamb.

5. The door closer of claim 1, wherein the fasteners are screws.

6. A door closer that protects the part of the door jamb to which the door closer is attached, comprising:
mounting plate for attaching the door closer to a part of the door jamb.
the mounting plate being substantially flat and being sized horizontally to cover the horizontal part of the doorjamb to which the mounting plate is attached,
the mounting plate being substantially flat, and
the mounting plate being attached by at least six fasteners to the doorjamb;
an extension being connected substantially perpendicularly to one face of the mounting plate,
the extension being connected approximately on the center left side of the mounting plate, and
the extension having a pin at its distal end from the mounting plate;
a closer having a spring element with an extendible arm connected in a generally horizontally rotatable manner to the pin of the extension, and
the closer including an end element attached at the end of the closer opposite to the pin; and
the end element attached to a door mounting plate.

7. The door closer of claim 6, wherein the end element is attached in a limited horizontally slidable fashion to the door mounting plate.

8. The door closer of claim 6, wherein the extension is substantially triangularly shaped with the pin at the apex of the extension.

9. The door closer of claim 6, wherein the mounting plate is attached by at least seven fasteners to the doorjamb.

10. The door closer of claim 6, wherein the mounting plate is attached by at least eight fasteners to the doorjamb.

11. The door closer of claim 6, wherein the mounting plate is attached by at least nine fasteners to the doorjamb.

12. The door closer of claim 6, wherein the fasteners are screws.

13. The door closer of claim 6, wherein the mounting plate is substantially square.

14. A closer for closing an element over a jamb lined opening, comprising:
a jamb bracket including a mounting plate and a bracket extension;
the mounting plate being sized horizontally to cover at least the horizontal part of the jamb to which the mounting plate is attached,
the mounting plate being substantially flat, and
the mounting plate being attached by at least six fasteners to the jamb;
the bracket extension of the jamb bracket being connected substantially perpendicularly to one face of the mounting plate,
the bracket extension being connected approximately on the center left side of the mounting plate, and
the bracket extension having a pin at its distal end from the mounting plate;
a closer having a spring element with an extendible arm connected in a generally horizontally rotatable manner to the pin of the bracket extension, and
the closer including an end element attached at the end of the closer opposite to the pin; and
the end element attached to the element.

15. The closer of claim 14, wherein the element comprises a door.

16. The closer of claim 14, wherein the element comprises a lid; and
wherein the jamb lined opening comprises an open topped container.

17. The closer of claim 14, wherein the element comprises a cover; and
wherein the jamb lined opening comprises an open topped box.

18. The closer of claim 14, wherein the mounting bracket is substantially square.

19. The closer of claim 14, wherein the mounting plate is attached by at least nine fasteners to the element.

20. The closer of claim 14, the fasteners are bolts.
